(19) United States
(12) Patent Application Publication
(10) Pub. No.: US 2022/0040888 A1
(43) Pub. Date: Feb. 10, 2022

(54) Recycling Device

(71) Applicant: Rennie West, Carson, CA (US)

(72) Inventor: Rennie West, Carson, CA (US)

(21) Appl. No.: 17/395,818

(22) Filed: Aug. 6, 2021

Related U.S. Application Data
(60) Provisional application No. 63/062,641, filed on Aug. 7, 2020.

(51) Int. Cl. B29B 17/00; B30B 9/32

(52) U.S. Cl. CPC B29B 17/0052; B29B 2017/0057; B29B 2017/0068; B30B 9/325

(57) ABSTRACT

A recycling device stowable beneath a countertop for compressing bottles. The recycling device includes a housing having a chamber and a heating element capable of applying a moderate heat to the bottles received therein. The chamber includes a funnel section and an upper opening removably covered by a door, wherein the door can open to allow for depositing of the bottles within the chamber and close to restrict access to the chamber during the actuation of the heating element. The funnel section can direct the bottles to a specific orientation directly adjacent to the heating element, wherein a compression assembly positioned below the funnel section can reduce a volume of the bottle by collapsing the sidewalls of the bottle. In some embodiments, the door is operably connected to the heating element and the compression assembly such that upon closing of the door, the heating element and the compression assembly activate.

### CROSS REFERENCE TO RELATED APPLICATION

This application claims the benefit of U.S. Provisional Application No. 63/062,641 filed on Aug. 7, 2020. The above identified patent application is herein incorporated by reference in their entirety.

### BACKGROUND OF THE INVENTION

The present invention relates to a recycling device. The present invention further provides a recycling device for compressing empty bottles. Specifically, the present invention provides a heating element for ease of bottle compression.

Recycling is a vital tool in combatting the many environmental problems around the world. This practice primarily consists of disposing of paper, glass, and plastic products in a separate container than the trash. These products are then taken to a facility and sorted for reuse. However, the practice of recycling takes up a large amount of space. One of the most commonly recycled objects are bottles. Bottles are often comprised of a thin plastic material. When recycled, the insides of the bottles are emptied and rinsed, leaving a substantial volume of unused space. Because of this, recycling bins often fill up quickly, resulting in overflow or the need for multiple recycling bins.

There exists prior art for the compression devices for bottles. However, these devices fail to orient the bottles in a specified position via a gravity fed funnel in order to make heating and compressing the bottle more efficient. Further, these devices fail to provide a compression assembly having a pair of rotors adapted to cooperatively flatten the bottle therebetween and along a lateral axis thereof. Therefore, there exists a need in the prior art to provide a recycling device that is configured for orienting bottles horizontally or vertically through a gravity fed funnel system.

In light of the devices disclosed in the known art, it is submitted that the present invention substantially diverges in design elements and methods from the known art and consequently it is clear that there is a need in the art for an improvement for recycling devices. In this regard the instant invention substantially fulfills these needs.

### SUMMARY OF THE INVENTION

In view of the foregoing disadvantages inherent in the known types of recycling devices now present in the known art, the present invention provides a new recycling device wherein a plastic bottle is configured to be oriented horizontally in a chamber via a funnel system, wherein the bottle is heated and compressed by rotors.

It is an objective of the present invention to provide an embodiment of the recycling device comprising a housing having a chamber adapted to receive bottles therein, wherein the chamber includes a funnel section adapted to direct the bottle to a specific position directly adjacent from the heating element. The heating element is positioned annularly about the funnel section to provide thermal energy to the sidewalls of the bottle when they are oriented in the vertical or horizontal position. The heated bottle requires less force to compress or flatten than a bottle at normal atmospheric temperature as the molecules are farther apart. Positioned below the vertical section is a compression assembly, wherein the compression assembly is adapted to reduce the volume of the bottle by collapsing the sidewalls thereof. The compression assembly comprises a pair of rotors adapted to cooperatively receive the bottle therebetween in a gap. As the rotors rotate, the bottle is forced into the gap, wherein the gap is substantially narrower than the bottle. Thereby, causing the bottle to compress along a lateral axis. A collection bin is positioned beneath the compression assembly to capture the compressed bottle after it drops from the rotors.

It is another objective of the present invention to provide an embodiment of the recycling device wherein the rotors include teeth adapted for facilitating movement from the funnel to the narrow gap. In this embodiment, the teeth ensure passage through the compression assembly.

It is another objective of the present invention to provide an embodiment of the recycling device wherein a door removably covers an upper opening of the chamber. The door must be opened for the bottle to be inserted into the funnel. The door is operably connected to the heating element and the compression assembly such that upon closing of the door, the heating element and the compression assembly activate. The housing also includes motion sensors for detecting the presence of the bottle, and the position of the door. In the closed position, the door may be locked to prevent opening until a heating and compression cycle has completed for safety.

It is an objective of the present invention to provide a recycling device having versatile rotors to facilitate compression and locking mechanisms for prohibiting access during heating and compression.

It is yet another objective of the present invention to provide a recycling device that promotes beneficial environmental behavior. The plastic recycling system minimizes the volume of the bin needed for proper recycling and maximizes the number of plastic bottles that can be recycled at once.

It is therefore an object of the present invention to provide a new and improved recycling device that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a first embodiment of the recycling device.

FIG. 2 shows a partial cross-sectional view of a front side of a first embodiment of the recycling device.

FIG. 3 shows a cross-sectional view of an upper end of an embodiment of the recycling device.

FIG. 4 shows a perspective view of another embodiment of the recycling device.

FIG. 5 shows a block diagram of a control circuit of an embodiment of the recycling device.

FIG. 6 shows a perspective view of an embodiment of the recycling device installed within a residential kitchen.

### DETAILED DESCRIPTION OF THE INVENTION

Reference is made herein to the attached drawings. Like reference numerals are used throughout the drawings to depict like or similar elements of the recycling device. For the purposes of presenting a brief and clear description of the present invention, the preferred embodiment will be discussed as used for heating and compressing bottles and other containers. The figures are intended for representative purposes only and should not be considered to be limiting in any respect.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment. As used herein, “bottle”, “bottles”, “cans”, “containers”, and the like are used interchangeably. In one embodiment, the cans are twelve-ounce aluminum cans.

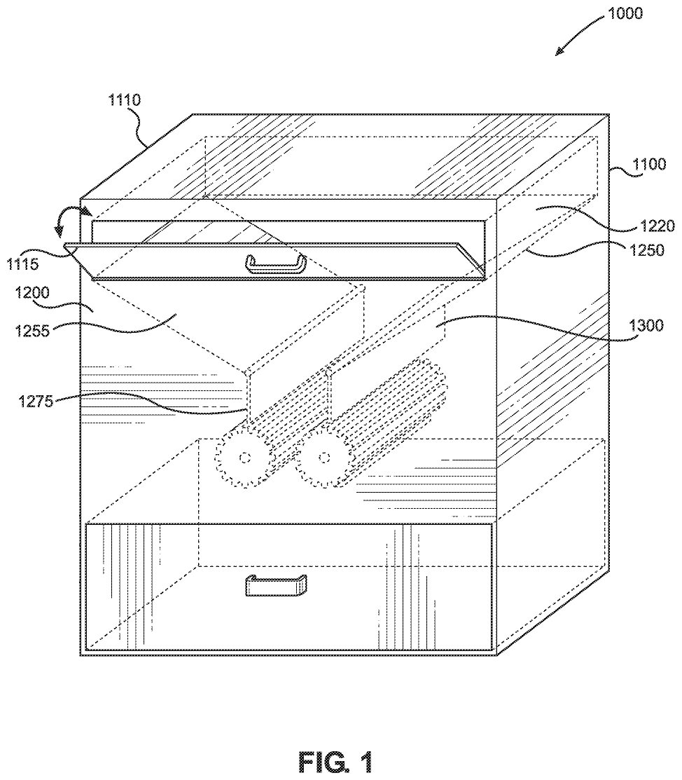

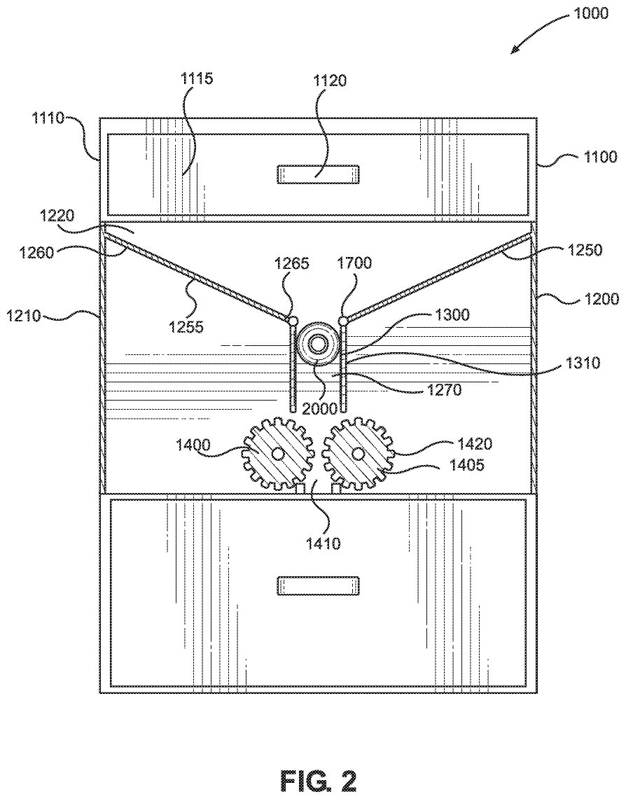

Referring now to FIGS. 1 and 2, there is shown a perspective view of a first embodiment of the recycling device and a partial cross-sectional view of a front side of a first embodiment of the recycling device, respectively. The recycling device 1000 comprises a housing 1100 having a chamber 1200 and a heating element 1300, wherein the heating element 1300 is configured to heat bottles received in the chamber 1200. The chamber 1200 comprises a sidewall 1210, an open upper end 1220, and a funnel section 1250 adapted to direct a bottle 2000 to a horizontal position. In other embodiments, the bottles 2000 are directed to a vertical position or any other suitable orientation for efficient heating and compacting thereof. In one embodiment, the funnel section includes positioning members that assist with orienting the bottle 2000 into a desired position. These positioning members extend from the funnel section 1250 such that as the bottle rolls or slides down the funnel section 1250, the positioning members knock the bottle 2000 into a desired position prior to entering the chamber 1200.

In the illustrated embodiment the chamber 1200 comprises a substantially quadrilateral shaped cross section with an open interior. However, in alternate embodiments, the chamber 1200 comprises any suitable shape wherein the housing is adapted to fit within a residential home such as beneath a kitchen countertop or cabinet. The open upper end 1220 is removably covered by a top section 1110 of the housing 1100. The top section 1110 of the housing 1100 comprises a door 1115 or similar mechanism that serves as a gate for allowing or preventing bottles to pass from the exterior into the interior of the chamber 1200. The door 1115 is adapted to selectively open and close for controlling access to the interior of the housing 1100. In some embodiments, the door 1115 opens to allow for depositing of the bottles within the chamber 1200 and closes to restrict access to the chamber 1200 during the actuation of the heating element 1300. In some embodiments, the door 1115 comprises a handle 1120. In the illustrated embodiment, the door 1115 is pivotally secured to the housing 1100 at a lower edge of the door and opens when the handle 1120 is pulled downwards. In other embodiments, the door 1115 is configured as a drawer and opens when the handle is pulled.

The funnel section 1250 is positioned below the open upper end 1220 of the chamber 1200 and is configured to direct the bottles 2000 to a horizontal position directly adjacent to the heating element 1300. The funnel section 1250 comprises a pair of platforms 1255 having a first end 1260 and a second end 1265. The first end 1260 of each platform 1255 extends from an upper end of an opposing interior side of the sidewall 1210, wherein the second end 1265 of each platform 1255 terminate at a pair of vertical members 1275 such that a first gap 1270 is formed between each platform 1255 and vertical member 1275. The platforms are slanted wherein the second end 1265 of the platform 1255 is positioned at a lower elevation within the chamber 1200 than the first end 1260 such that as a bottle is tossed in the housing, the bottle will roll along the platform 1255 and be directed within the first gap. As the bottle travels into the funnel section, the narrowed width forces the bottle to lay flat or horizontally.

The first gap 1270 is configured to receive the bottles 2000 therein. In the illustrated embodiment, the first gap 1270 is between 2-3.5 inches wide, wherein the width is measured as the distance between the two second ends of the platform 1255. This width provides a first gap that is wide enough to receive most conventional plastic bottles configured to hold less than 2 liters of liquid therein. This also allows the dimension of the recycling device to remain compact so as to fit within a residential kitchen. In some embodiments, the first gap in less than 4.5 inches so as to be able to receive standard 2-liter soda bottles therein.

In the illustrated embodiment, the heating element 1300 is positioned about the funnel section 1250. In this way, as the bottle 2000 is disposed within the funnel section 1250, thermal energy is applied to the sidewalls of the bottle 2000 while in the horizontal position. In some embodiments, the heating element 1300 comprises a pair of heating plates 1310 embedded with or in replacement of the vertical members 1275 of the funnel section 1250, wherein the heating plates are disposed on opposing sides of the funnel section 1250. The benefit of the heating element 1300 is that a heated bottle requires less force to compress or flatten than a bottle at normal atmospheric temperature. In other embodiments, the heating element 1300 is a heating coil disposed within the vertical members. In alternate embodiments, the recycling device 1000 comprises any suitable heating element configured to apply heat to a bottle when positioned in a horizontal orientation within the gap.

The recycling device 1000 further comprises a compression assembly 1400 disposed below the funnel section 1250 and adapted to reduce a volume of the bottle 2000 by collapsing the sidewall thereof. In the illustrated embodiment, the compression assembly comprises a pair of rotors 1405 adapted to cooperatively receive the bottle 2000 therebetween in a second gap 1410 disposed below the first gap 1270. As the rotors 1405 rotate, the bottle 2000 is forced into the second gap 1410, wherein the second gap 1410 is substantially narrower than the first gap 1270 and the bottle 2000. Thereby, causing the bottle 2000 to compress along a lateral axis. In the illustrated embodiment, the recycling device 1000 includes two rotors 1405 at the posterior ends of the heating plates 1310. In the illustrated embodiment, the rotors 1405 are cylindrical with minimal distance between each face forming the second gap 1410. In one embodiment, the rotors 1405 include teeth 1420 adapted to assist with the movement of the bottle 2000 through the compression assembly 1400.

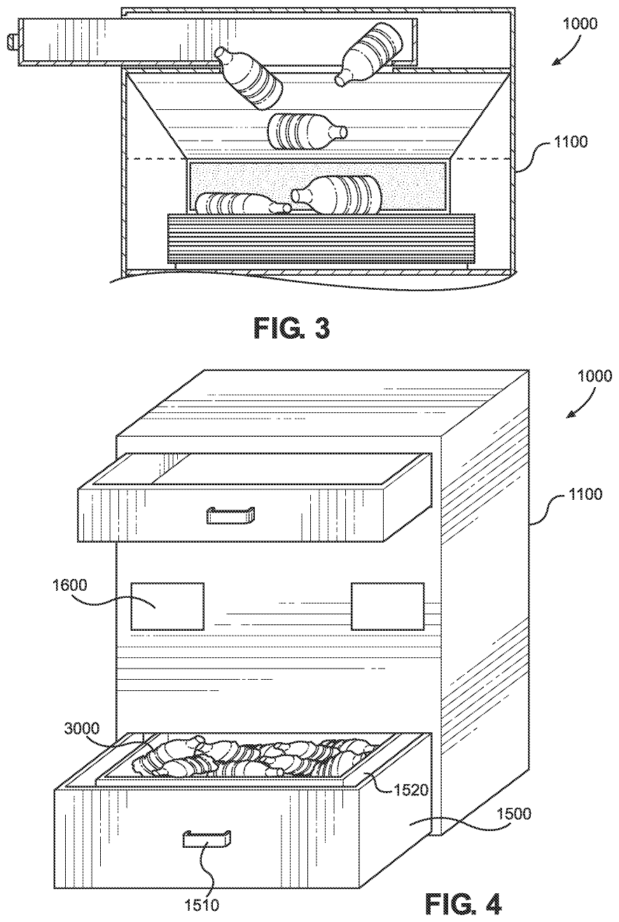

Referring now to FIGS. 3 and 4, there is shown shows a perspective view of another embodiment of the recycling device and cross-sectional view of an upper end of an embodiment of the recycling device, respectively. In the illustrated embodiment, a collection bin 1500 is positioned beneath the compression assembly 1400 to capture the compressed bottle 2000 after it drops from the rotors. The collection bin 1500 is separable from the housing 1100 such that the compressed bottles 2000 can be accessed and removed from the housing 1100, distinct from the open upper end of the chamber. In the illustrated embodiment, the collection bin 1500 comprises a same cross-sectional shape of the chamber in order to fit within the housing 1100 and efficiently store compressed bottles therein. In some embodiments, the collection bin 1500 comprises a handle 1510 on an exterior to pull out as a drawer. In alternate embodiments, there is a receptacle 1520 within the collection bin 1500 that is removable so to allow a user to pick up the receptacle and empty the contents therein to a recycling bin or the like.

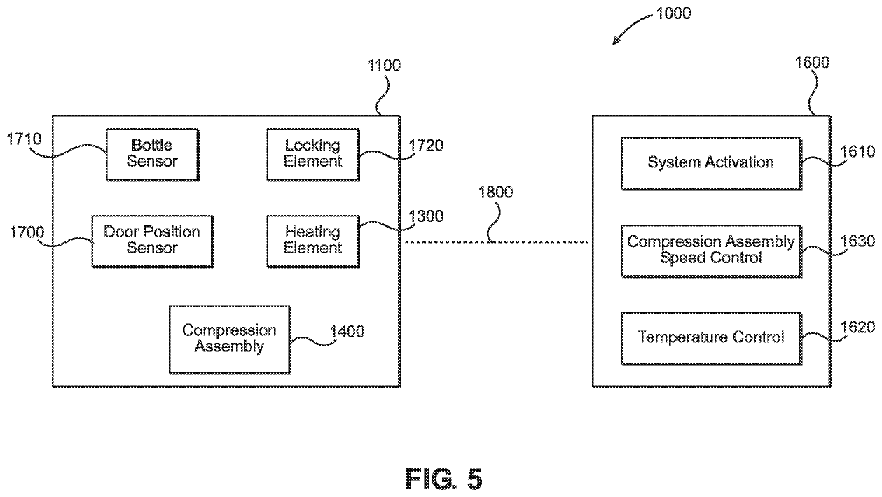

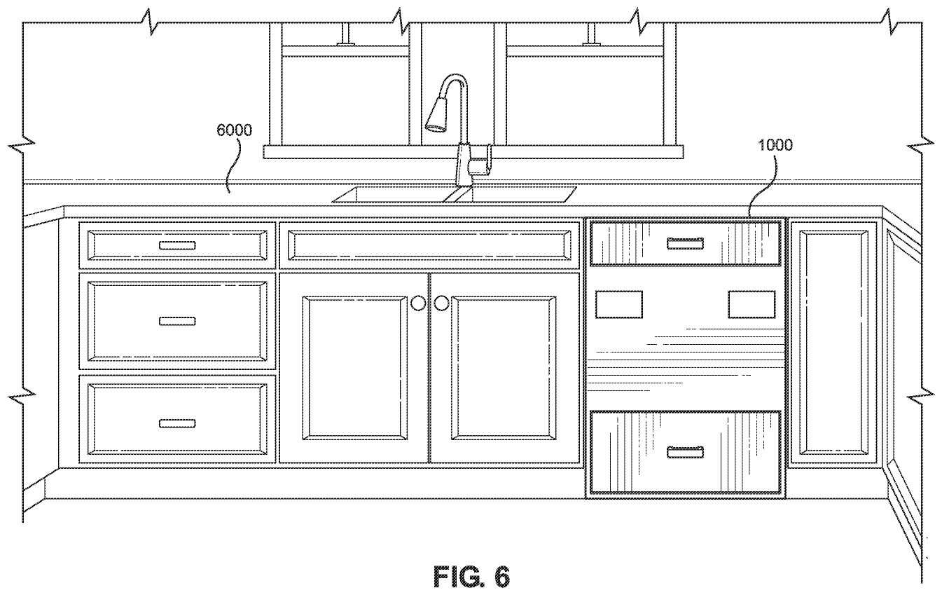

Referring now to FIG. 5, there is shown a block diagram of a control circuit of an embodiment of the recycling device. In some embodiments, a sensor is disposed within the housing 1100 for detecting a bottle within the chamber and/or a position of the door. The position of the door being an open position or a closed position. In the illustrated embodiment, a motion sensor 1700 is used to detect a bottle passing through the funnel section into the first gap between the heating element 1300. The motion sensor 1700 is disposed at the second end of the platforms of the funnel section. A pressure sensor 1710 is used in some embodiments to detect whether the door is in an open or a closed position. The pressure sensor is located along a perimeter of the housing 1100 that contacts the door in a closed position. In alternate embodiments, other types of sensors are used for detecting the bottle and a position of the door, such as a proximity sensor, contact sensor, non-contact sensor, and the like.

The motion sensor 1700 is configured to activate the heating element 1300 and the rotors of the compression assembly 1400 when the door is closed and a bottle is detected. The door is operably connected to the heating element 1300 and the compression assembly 1400 such that upon closing of the door, the heating element 1300 and the compression assembly 1400 activate. In some embodiments, the door comprises a locking element 1720 such that in the closed position, the door may be locked to prevent opening until a heating and compression cycle has completed for safety. Any suitable automated locking system is contemplated in this embodiment. In alternate embodiment, a latch or non-automated lock is used to prevent access to the chamber.

In the illustrated embodiment, a control panel 1600 is operably connected to the control circuit of the housing. In some embodiments, the housing comprises a display of the control panel, such as a touch screen. In alternate embodiments, the control panel 1600 is wirelessly connected 1800 to the housing 1100 to control and monitor the operation of the recycling device 1000. In the wireless embodiment, an application can be accessed through a smart device to control and monitor the recycling device 1000. In the illustrated embodiment, the control panel 1600 comprises a system activation actuator 1610 to turn on and off the recycling device, by deactivating the sensors, which causes the heating element and compression assembly to be deactivated. In alternate embodiments, the control panel 1600 comprises access to the locking element to remotely lock or unlock the door.

In the illustrated embodiment, the control panel 1600 comprises a temperature control 1620 that allows a user to control the temperature of the heating element 1300. In some embodiments, the temperature range of the heating element 1300 is approximately 70-100 degrees Celsius. The heating element 1300 is configured not to emit heat of greater than 120 degrees Celsius to prevent the bottles from emitting any toxins when heated. In some embodiments, the control panel 1600 further comprises a compression assembly speed control 1630 adapted to control the speed of the rotors. If a user has many bottles to compress in a short amount of time, the compression assembly speed can be increases.

In some embodiments, the heating element 1300 and the compression assembly are activated simultaneously and as the bottle passes through the first gap it is adequately heated and is subsequently crushed as it falls into the compression assembly via gravity. In other embodiments, the heating element 1300 is activated first for a predetermined period of time, wherein after the predetermined period of time has elapsed the compression assembly is activated. In some embodiments, the predetermined period of time is 1-10 seconds. The bottle rests atop the compression assembly until the compression assembly is activated after which the bottle is pulled into the rotors and crushed.

In some embodiments, the compression assembly of the recycling device can be activated without activating the heating element. In this way, the recycling device does not output additional energy to apply heat to the bottles prior to passing through the compression assembly.

Referring now to FIG. 6, there is shown a perspective view of an embodiment of the recycling device installed within a residential kitchen. The recycling device is adapted to receive, heat, and compress empty bottles for easy disposal and reducing plastic bottle clutter within a garbage container, as well as on a countertop. In some embodiments, the housing 1100 of the recycling device 1000 comprises a substantially rectangular cross sectioned shape having a width of approximately 1 to 1.5 feet and a height of 2 to 3 feet. The recycling device 1000 is configured to be installed beneath a countertop of a residential kitchen.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A recycling device comprising:
a housing having a chamber and a heating element configured to heat a bottle received therein;
wherein the chamber comprises a funnel section and an upper opening adapted to receive the bottle through a door of the housing;
wherein the funnel section is configured to direct the bottle to a horizontal position directly adjacent to the heating element;
a compression assembly disposed below the funnel section and adapted to reduce a volume of the bottle by crushing the sidewall thereof.

2. The recycling device of claim 1, wherein the funnel section comprises a pair of platforms each having a first end and a second end, the first end extending from an upper end of an opposing interior side of a sidewall of the housing and the second end terminating at a pair of vertical members such that a first gap is formed between each platform and vertical member.

3. The recycling device of claim 2, wherein the second end of the platform is positioned at a lower elevation within the chamber than the first end such that the bottle is adapted to roll along the platform and into the first gap.

4. The recycling device of claim 2, wherein a sensor for detecting the presence of the bottle within the chamber, the sensor positioned at the second end of the pair of platforms.

5. The recycling device of claim 1, wherein the door is adapted to open to allow for depositing of the bottle within the chamber and to close to restrict access to the chamber during the actuation of the heating element.

6. The recycling device of claim 5, wherein a sensor is disposed along a perimeter of the housing that contacts the door in a closed position to detect whether the door is in an open position or a closed position.

7. The recycling device of claim 1, wherein the heating element is positioned about the funnel section to provide thermal energy to a sidewall of a bottle in the horizontal position.

8. The recycling device of claim 2, wherein the compression assembly comprises a pair of rotors adapted to cooperatively receive the bottle therebetween in a second gap.

9. The recycling device of claim 8, wherein the first gap is positioned directly above the second gap, the second gap being smaller in width than the first gap.

10. The recycling device of claim 9, further comprising a collection bin positioned beneath the compression assembly to capture the compressed bottle after it drops from the rotors.

11. The recycling device of claim 10, further comprising a receptacle within the collection bin adapted to be separated therefrom and completely removed from the housing.

12. The recycling device of claim 1, wherein the door is operably connected to the heating element and the compression assembly such that upon closing of the door, the heating element and the compression assembly activate.

13. The recycling device of claim 12, further comprising a motion sensor disposed within the housing adapted to detect the bottle within the chamber and an open position or closed position of the door.

14. The recycling device of claim 13, wherein the compression assembly comprises a pair of rotors each having teeth adapted to assist with the movement of the bottle through the compression assembly.

15. The recycling device of claim 14, wherein the recycling device is no greater than 3 feet in height such that the recycling device is configured to fit beneath a residential kitchen countertop.

16. The recycling device of claim 4, further comprising a control panel configured to allow a user to activate and deactivate the sensor and lock or unlock a locking element operably connected to the door of the housing.

17. The recycling device of claim 16, wherein the control panel is remote relative to the housing.

18. The recycling device of claim 16, wherein the control panel is a display located on an exterior of the housing.

19. The recycling device of claim 16, wherein the control panel comprises a temperature control for increasing or decreasing a temperature of the heating element.

20. The recycling device of claim 19, wherein the control panel comprises a compression assembly speed control to increase or decrease the speed of compression.
